(19) United States
(12) Patent Application Publication
(10) Pub. No.: US 2014/0269911 A1
(43) Pub. Date: Sep. 18, 2014

(54) BATCH COMPRESSION OF PHOTOS

(71) Applicant: DROPBOX INC., San Francisco, CA (US)

(72) Inventor: Thomas Walter KLEINPETER, III, San Francisco, CA (US)

(73) Assignee: Dropbox Inc., San Francisco, CA (US)

(21) Appl. No.: 13/800,101

(22) Filed: Mar. 13, 2013

(51) Int. Cl. H04N 7/26

(52) U.S. Cl. CPC H04N 19/00781
USPC 375/240.12

(57) ABSTRACT

Embodiments are provided for batch compression of photos. In some embodiments, first and second images are selected, each image comprising a plurality of individual blocks and each individual block is defined by at least one matrix whose values are indicative of pixel data within the individual block. For each individual block of the second image, comparing a chosen individual block of the second image to each individual block within at least one region of the first image. The comparing including calculating a difference block between the chosen block of the second image and a chosen block within the at least one region of the first image, the difference block comprising a difference between corresponding matrix values of the two blocks being compared, and calculating a sum for the calculated difference block as a similarity metric for the two blocks being compared. A similar difference block is provided from the calculated difference blocks for inclusion in a difference representation based on the corresponding sum, the similar difference block operable with the chosen block within the at least one region of the first image to reconstruct the chosen individual block of the second image, and compressing the difference representation and the first image, where the difference representation is operable with the first image to reconstruct the second image, and transmitting the compressed information.

### FIELD OF THE INVENTION

Various embodiments relate generally to compression of images and transmission of image files.

### BACKGROUND

Recent technological advancement in capturing and recording images include features that allow users to capture and record images in rapid succession, often within microseconds or seconds of each other, thus creating large sets of user photos. With the decrease in costs for storage, users often store a large number of their captured photos both on their cameras and in remote storage. Instead of reviewing and deleting near duplicates before uploading, such as photos captured in rapid succession and with slight differences between them, users simply upload the entire set to content management systems to store, manage, share, and review their captured images.

Prior to upload to the content management system, compression may be used to reduce the size of the image files and thus the amount of data transmitted for each image file. However, currently, compression algorithms are only applied to a single image file and do not exploit the similarities between the images in their compression techniques. Transmission of large amounts of image files, even compressed files, can be particularly slow when there are bandwidth constraints. This can result in a reduction of the battery life for the mobile device. Thus, there is a need for improved compression and transmission mechanisms.

### SUMMARY

Embodiments are provided for batch compression of photos. In some embodiments, first and second images are selected, each image comprising a plurality of individual blocks and each individual block is defined by at least one matrix whose values are indicative of pixel data within the individual block. For each individual block of the second image, comparing a chosen individual block of the second image to each individual block within at least one region of the first image. The comparing including calculating a difference block between the chosen block of the second image and a chosen block within the at least one region of the first image, the difference block comprising a difference between corresponding matrix values of the two blocks being compared, and calculating a sum for the calculated difference block as a similarity metric for the two blocks being compared. A similar difference block is provided from the calculated difference blocks for inclusion in a difference representation based on the corresponding sum, the similar difference block operable with the chosen block within the at least one region of the first image to reconstruct the chosen individual block of the second image, and compressing the difference representation and the first image, where the difference representation is operable with the first image to reconstruct the second image, and transmitting the compressed information.

### BRIEF DESCRIPTION OF THE DRAWINGS

It is noted that the U.S. patent or application file contains at least one drawing executed in color. Copies of this patent or patent application publication with color drawings will be provided by the U.S. Patent Office upon request and payment of the necessary fee. The above and other aspects and advantages of the invention will become more apparent upon consideration of the following detailed description, taken in conjunction with accompanying drawings, in which like reference characters refer to like parts throughout, and in which:

FIG. 1 is an exemplary system for batch compression of photos in accordance with some embodiments of the invention;

FIG. 2 is a flowchart for batch compression of photos in accordance with some embodiments of the invention;

FIG. 3 illustrates exemplary blocks from images and a difference representation for batch compression of photos in accordance with some embodiments of the invention;

FIG. 4 is a flowchart for batch compression of photos in accordance with some embodiments of the invention;

FIG. 5 is a flowchart for batch compression of photos in accordance with some embodiments of the invention;

FIG. 6 is a flowchart for batch compression of photos in accordance with some embodiments of the invention;

FIG. 7 is a flowchart for batch compression of photos in accordance with some embodiments of the invention;

FIG. 8A illustrates an exemplary similarity candidate for batch compression in accordance with some embodiments of the invention;

FIG. 8B illustrates an exemplary similarity candidate for batch compression in accordance with some embodiments of the invention; and

FIG. 8C illustrates an exemplary difference representation in accordance with some embodiments of the invention.

### DETAILED DESCRIPTION OF THE DISCLOSURE

Methods, systems, and computer readable mediums for batch compression of photos are provided. A batch compression algorithm may be used to decrease the amount of data transmitted between devices when transmitting similar images. When a first image and a second image are compared and determined to be similar, the first image may be transmitted along with a difference representation having a numeric representation for the differences between the first and the second images. The difference representation may be used for reconstruction of the second image at the receiving device instead of necessitating the transmittal of the first and the second images.

A mapping between the individual blocks of the first image and the individual blocks of the difference representation may be transmitted to the receiving device to allow for reconstruction of the second image, and the receiving device can reconstruct the second image using the mapping to locate the individual blocks of the first image for each of the corresponding blocks in the difference representation to reconstruct each block of the second image.

In particular, by transmitting a first image, a difference representation with differences between the first image and a second image, and a mapping instead of the first and second images between devices, the amount of data transmitted may be reduced. For example, a compressed first image, a compressed difference representation, and a mapping may be uploaded from a client device to a content management system when a first image and a second image are found to be similar. In another example, when the content management system provides services such as the synchronization of images and/or the provision of shared images to the client devices, similar images can be further compressed using batch compression to reduce the information transmitted.

For purposes of description and simplicity, methods, systems and computer readable mediums will be described for a content storage and management service. However, the term “content storage service” is used herein to refer broadly to a variety of storage providers/services and types of content, files, portions of files, and/or other types of data. Those with skill in the art will recognize that the methods, systems, and mediums described for a content storage service may be used for a variety of storage providers/services and types of content, files, portions of files, and/or other types of data.

FIG. 1 is an exemplary system for batch compression of photos in accordance with some embodiments of the invention. Elements in FIG. 1, including, but not limited to, first client electronic device 102a, second client electronic device 102b, and content management system 100 may communicate by sending and/or receiving data over network 106. Network 106 may be any network, combination of networks, or network devices that can carry data communication. For example, network 106 may be any one or any combination of LAN (local area network), WAN (wide area network), telephone network, wireless network, point-to point network, star network, token ring network, hub network, or any other configuration.

Network 106 can support any number of protocols, including but not limited to TCP/IP (Transfer Control Protocol and Internet Protocol), HTTP (Hypertext Transfer Protocol), WAP (wireless application protocol), etc. For example, first client electronic device 102a and second client electronic device 102b (collectively 102) may communicate with content management system 100 using TCP/IP, and, at a higher level, use browser 116 to communicate with a web server (not shown) at content management system 100 using HTTP. Examples of implementations of browser 116, include, but are not limited to, Google Inc. Chrome™ browser, Microsoft Internet Explorer®, Apple Safari®, Mozilla Firefox, and Opera Software Opera.

A variety of client electronic devices 102 can communicate with content management system 100, including, but not limited to, desktop computers, mobile computers, mobile communication devices (e.g., mobile phones, smart phones, tablets), televisions, set-top boxes, and/or any other network enabled device. Although two client electronic devices 102a and 102b are illustrated for description purposes, those with skill in the art will recognize that any number of devices may be used and supported by content management system 100. Client electronic devices 102 may be used to create, access, modify, and manage files 110a and 110b (collectively 110) (e.g. files, file segments, images, etc.) stored locally within file system 108a and 108b (collectively 108) on client electronic device 102 and/or stored remotely with content management system 100 (e.g., within data store 118). For example, client electronic device 102a may access file 110b stored remotely with data store 118 of content management system 100 and may or may not store file 110b locally within file system 108a on client electronic device 102a. Continuing with the example, client electronic device 102a may temporarily store file 110b within a cache (not shown) locally within client electronic device 102a, make revisions to file 110b, and the revisions to file 110b may be communicated and stored in data store 118 of content management system 100. Optionally, a local copy of the file 110a may be stored on client electronic device 102a.

In particular, client devices 102 may capture, record, and/or store image files 110. Client devices 102 may have a camera 138 (e.g., 138a and 138b) to capture and record images. A compression module 136 (e.g., 136a and 136b) may be used to compress and decompress image files. The compression module 136 may utilize any compression algorithms, including, but not limited to, algorithms implementing at least a portion of a Joint Photographic Expert Group (JPEG) standard. The compression module 136 may be used to identify similar images to employ further batch compression techniques in order to reduce the amount of data transmitted to devices 102 and content management system 100. For example, compression module 136a may identify a first image and a second image are similar and record a difference between the images. Continuing with the example, the data transmission to upload the image file may be reduced by transmitting the first image and the difference to a counterpart compression module (e.g., 140 and/or 136b) and the counterpart compression module may then reconstruct the second image using the first image and the difference.

Files 110 managed by content management system 100 may be stored locally within file system 108 of respective devices 102 and/or stored remotely within data store 118 of content management system 100 (e.g., files 134 in data store 118). Content management system 100 may provide synchronization of files managed by content management system 100. Attributes 112a and 112b (collectively 112) or other metadata may be stored with files 110 to track files locally stored on client devices 102 that are managed and/or synchronized by content management system 100. For example, attributes 112 may be implemented using extended attributes, resource forks, or any other implementation that allows for storing metadata with a file that is not interpreted by a file system. In some embodiments, attributes 112a and 112b may be content identifiers for a file. For example, the content identifier may be a unique or nearly unique identifier (e.g., number or string) that identifies the file.

By storing a content identifier with the file, a file may be tracked. For example, if a user moves the file to another location within the file system 108 hierarchy and/or modifies the file, then the file may still be identified within the local file system 108 of a client device 102. Any changes or modifications to the file identified with the content identifier may be uploaded or provided for synchronization and/or version control services provided by the content management system 100.

A stand-alone content management application 114a and 114b (collectively 114), client application, and/or third-party application may be implemented to provide a user interface for a user to interact with content management system 100. Content management application 114 may expose the functionality provided with content management interface 104. Web browser 116a and 116b (collectively 116) may be used to display a web page front end for a client application that can provide content management 100 functionality exposed/provided with content management interface 104.

Content management system 100 may allow a user with an authenticated account to store content, as well as perform management tasks, such as retrieve, modify, browse, synchronize, and/or share content with other accounts. Various embodiments of content management system 100 may have elements, including, but not limited to, content management interface module 104, account management module 120, synchronization module 122, collections module 124, sharing module 126, file system abstraction 128, data store 118, and compression module 140. The content management service interface module 104 may expose the server-side or back end functionality/capabilities of content management system 100. For example, a counter-part user interface (e.g., stand-alone application, client application, etc.) on client electronic devices 102 may be implemented using content management service interface 104 to allow a user to perform functions offered by modules of content management system 100.

In particular, content management system 100 may have a compression module 140 for identifying similar content, recording a difference between two pieces of content, and transmitting one of the similar files and a difference between the files to reduce data transmission between devices. Compression module 140 may also reconstruct content (e.g., images) using a received difference between two files and a mapping between the difference and the similar images.

The user interface provided on client electronic device 102 may be used to create an account for a user and authenticate a user to use an account using account management module 120. The account management module 120 of the content management service may provide the functionality for authenticating use of an account by a user and/or a client electronic device 102 with username/password, device identifiers, and/or any other authentication method. Account information 130 can be maintained in data store 118 for accounts. Account information may include, but is not limited to, personal information (e.g., an email address or username), account management information (e.g., account type, such as “free” or “paid”), usage information, (e.g., file edit history), maximum storage space authorized, storage space used, content storage locations, security settings, personal configuration settings, content sharing data, etc. An amount of content management may be reserved, allotted, allocated, stored, and/or may be accessed with an authenticated account. The account may be used to access files 110 within data store 118 for the account and/or files 110 made accessible to the account that are shared from another account. Account module 124 can interact with any number of other modules of content management system 100.

An account can be used to store content, such as documents, text files, audio files, video files, etc., from one or more client devices 102 authorized on the account. The content can also include folders of various types with different behaviors, or other mechanisms of grouping content items together. For example, an account can include a public folder that is accessible to any user and the public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

Content items (e.g., files 110) can be stored in data store 118 (e.g., files 134). Data store 118 can be a storage device, multiple storage devices, or a server. Alternatively, data store 118 can be cloud storage provider or network storage accessible via one or more communications networks. Content management system 100 can hide the complexity and details from client devices 102 by using a file system abstraction 128 (e.g., a file system database abstraction layer) so that client devices 102 do not need to know exactly where the content items are being stored by the content management system 100. Embodiments can store the content items in the same folder hierarchy as they appear on client device 102. Alternatively, content management system 100 can store the content items in various orders, arrangements, and/or hierarchies. Content management system 100 can store the content items in a network accessible storage (SAN) device, in a redundant array of inexpensive disks (RAID), etc. Content management system 100 can store content items using one or more partition types, such as FAT, FAT32, NTFS, EXT2, EXT3, EXT4, ReiserFS, BTRFS, and so forth.

Data store 118 can also store metadata describing content items, content item types, and the relationship of content items to various accounts, folders, collections, or groups. The metadata for a content item can be stored as part of the content item or can be stored separately. Metadata can be store in an object-oriented database, a relational database, a file system, or any other collection of data. In one variation, each content item stored in data store 118 can be assigned a system-wide unique identifier.

Data store 118 can decrease the amount of storage space required by identifying duplicate files or duplicate chunks of files. Instead of storing multiple copies, data store 118 can store a single copy of a file 134 and then use a pointer or other mechanism to link the duplicates to the single copy. Similarly, data store 118 can store files 134 more efficiently, as well as provide the ability to undo operations, by using a file version control that tracks changes to files, different versions of files (including diverging version trees), and a change history. The change history can include a set of changes that, when applied to the original file version, produce the changed file version.

Content management system 100 can be configured to support automatic synchronization of content from one or more client devices 102. The synchronization can be platform independent. That is, the content can be synchronized across multiple client devices 102 of varying type, capabilities, operating systems, etc. For example, client device 102a can include client software, which synchronizes, via a synchronization module 122 at content management system 100, content in client device 102 file system 108 with the content in an associated user account. In some cases, the client software can synchronize any changes to content in a designated folder and its sub-folders, such as new, deleted, modified, copied, or moved files or folders. In one example of client software that integrates with an existing content management application, a user can manipulate content directly in a local folder, while a background process monitors the local folder for changes and synchronizes those changes to content management system 100. In some embodiments, a background process can identify content that has been updated at content management system 100 and synchronize those changes to the local folder. The client software can provide notifications of synchronization operations, and can provide indications of content statuses directly within the content management application. Sometimes client device 102 may not have a network connection available. In this scenario, the client software can monitor the linked folder for file changes and queue those changes for later synchronization to content management system 100 when a network connection is available. Similarly, a user can manually stop or pause synchronization with content management system 100.

A user can also view or manipulate content via a web interface generated and served by user interface module 104. For example, the user can navigate in a web browser to a web address provided by content management system 100. Changes or updates to content in the data store 118 made through the web interface, such as uploading a new version of a file, can be propagated back to other client devices 102 associated with the user's account. For example, multiple client devices 102, each with their own client software, can be associated with a single account and files in the account can be synchronized between each of the multiple client devices 102.

Content management system 100 can include sharing module 126 for managing sharing content and/or collections of content publicly or privately. Sharing content publicly can include making the content item and/or the collection accessible from any computing device in network communication with content management system 100. Sharing content privately can include linking a content item and/or a collection in data store 118 with two or more user accounts so that each user account has access to the content item. In particular, the sharing module 126 can be used with the collections module 124 to allow sharing of a virtual collection with another user or user account. The sharing can be performed in a platform independent manner. That is, the content can be shared across multiple client devices 102 of varying type, capabilities, operating systems, etc. The content can also be shared across varying types of user accounts.

In some embodiments, content management system 100 can be configured to maintain a content directory or a database table/entity for content items where each entry or row identifies the location of each content item in data store 118. A unique or a nearly unique content identifier may be stored for each content item stored in the data store 118. Metadata can be stored for each content item. For example, metadata can include a content path that can be used to identify the content item. The content path can include the name of the content item and a folder hierarchy associated with the content item (e.g., the path for storage locally within a client device 102). In another example, the content path can include a folder or path of folders in which the content item is placed as well as the name of the content item. Content management system 100 can use the content path to present the content items in the appropriate folder hierarchy in a user interface with a traditional hierarchy view. A content pointer that identifies the location of the content item in data store 118 can also be stored with the content identifier. For example, the content pointer can include the exact storage address of the content item in memory. In some embodiments, the content pointer can point to multiple locations, each of which contains a portion of the content item.

In addition to a content path and content pointer, a content item entry/database table row in a content item database entity can also include a user account identifier that identifies the user account that has access to the content item. In some embodiments, multiple user account identifiers can be associated with a single content entry indicating that the content item has shared access by the multiple user accounts.

To share a content item privately, sharing module 126 can be configured to add a user account identifier to the content entry or database table row associated with the content item, thus granting the added user account access to the content item. Sharing module 126 can also be configured to remove user account identifiers from a content entry or database table rows to restrict a user account's access to the content item. The sharing module 126 may also be used to add and remove user account identifiers to a database table for virtual collections.

To share content publicly, sharing module 126 can be configured to generate a custom network address, such as a uniform resource locator (URL), which allows any web browser to access the content in content management system 100 without any authentication. To accomplish this, sharing module 126 can be configured to include content identification data in the generated URL, which can later be used to properly identify and return the requested content item. For example, sharing module 126 can be configured to include the user account identifier and the content path in the generated URL. Upon selection of the URL, the content identification data included in the URL can be transmitted to content management system 100 which can use the received content identification data to identify the appropriate content entry and return the content item associated with the content entry.

To share a virtual collection publicly, sharing module 126 can be configured to generate a custom network address, such as a uniform resource locator (URL), which allows any web browser to access the content in content management system 100 without any authentication. To accomplish this, sharing module 126 can be configured to include collection identification data in the generated URL, which can later be used to properly identify and return the requested content item. For example, sharing module 126 can be configured to include the user account identifier and the collection identifier in the generated URL. Upon selection of the URL, the content identification data included in the URL can be transmitted to content management system 100 which can use the received content identification data to identify the appropriate content entry or database row and return the content item associated with the content entry or database row.

In addition to generating the URL, sharing module 126 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 126 can be configured to change the value of the flag to 1 or true after generating a URL to the content item.

In some embodiments, sharing module 126 can also be configured to deactivate a generated URL. For example, each content entry can also include a URL active flag indicating whether the content should be returned in response to a request from the generated URL. For example, sharing module 126 can be configured to only return a content item requested by a generated link if the URL active flag is set to 1 or true. Changing the value of the URL active flag or Boolean value can easily restrict access to a content item or a collection for which a URL has been generated. This allows a user to restrict access to the shared content item without having to move the content item or delete the generated URL. Likewise, sharing module 126 can reactivate the URL by again changing the value of the URL active flag to 1 or true. A user can thus easily restore access to the content item without the need to generate a new URL.

FIG. 2 is a flowchart for batch compression of photos for upload in accordance with some embodiments of the invention. A first and a second image may be captured and recorded with a camera, such as camera 138 of client device 102. The first and second images may each be a digital image having a numeric representation for the image. A digital image may have a finite set of pixels (e.g., rows and columns of pixels) to represent the image, and each pixel may have a quantized value for the brightness of a specific color or luminance at a particular point. For example, the digital image may have pixels with quantized values for color channels red, green, and blue (RGB).

In some embodiments, the first and the second images may be digital images that are compressed using a compression algorithm, such as a Joint Photographic Expert Group (JPEG) compression algorithm, and each image may be stored in one or more compressed files. By way of example, during JPEG compression, the representation of the colors for the image may be converted from RGB to color channels Y′C_{B}C_{R} for each pixel, consisting of one luma component (Y′), representing brightness, and two chroma components (C_{B} and C_{R}) representing color. Optionally, during JPEG compression, the data for the blocks of pixels may undergo a transformation by applying a Discrete Cosine Transform (DCT) to convert the data to the frequency domain, and data for the blocks may be represented as DCT coefficients. In such a case, the high frequency data that the human eye is less sensitive to may be discarded. Each image may be split into individual blocks, such as blocks with data for 8×8 pixels. Each individual block may be defined by at least one matrix or other numeric representation, or other mathematical construct whose values are indicative of pixel data within the block. For example, the data within the matrix, other numeric representation, or mathematical construct may be DCT coefficients. In another example, the data within the matrix may be or may be based on pixel values themselves. Although particular examples are provided that describe use of DCT coefficients, those with skill in the art will recognize that any transformation of pixel data, operation on pixel data, such as, for example, windowing or any other useful operation to represent or characterize pixel data, may be performed.

The first and the second images may be selected (200) as candidates for designation as similar images and further compression. Images are identified as similar when the images are found to contain similar blocks. The metadata associated with the first and the second images may indicate that the images are candidates for containing similar blocks. The first and second images may be selected as candidates based on criteria such as creation time, orientation of camera at capture, identification of camera that captured image, geolocation at capture, recognized as near duplicates using a duplicate detection algorithm, and/or any other criteria or algorithms to identify candidates for similarity. For example, images that have a creation time indicating the images were captured within a millisecond of each other may be good candidates for having similar blocks and batch compression.

To determine whether the first and the second images are similar, a comparison may be performed for each individual block of the second image (202). To perform the comparison for a chosen individual block, the chosen individual block of the second image is compared to each individual block within at least one region of the first image (204). The first image may be divided in to regions of individual blocks, and the chosen individual block of the second image may be compared to individual blocks of any number of regions of the first image. A region may have one or more individual blocks. In the simplest case, each individual block of the second image is compared to the corresponding individual block of the first image.

In some embodiments, each individual block of the second image is compared to a set of individual blocks in a particular region of the first image. By way of example, as illustrated in FIG. 3, block 310 of second image 314 may be compared to each block in region 312 of first image 300. The most similar block to the block 310 of second image 314 within the region 312 of first image 300 may be provided for the difference representation 302 and ultimately used to reconstruct block 310 at a receiving device. Those with skill in the art will recognize that the region is configurable and may vary based on the positioning of the block in the second image. For example, the region selected within the first image 300 for a block within the second image 314 may be centered around a block in the first image 300 having a corresponding position to the block within the second image 314. Continuing with the example, a region for block 310 may include blocks surrounding block 304 which has a corresponding position within first image 314 to the positioning of block 310 in second image 314. The region may have any height and width of blocks and/or portions of blocks surrounding a particular block in the first image (e.g., a 2×2 block region, a 3×3 block region, a 5×5 region, etc.). As shown, a 2×2 block region 312 is selected within first image 300 for block 310 of the second image 314, and the blocks for the region 312 surround block 304. In another example, a block at row 10 and column 10 of the second image may have a region centered around a block in the first image in a corresponding position that is a 11×11 square of blocks. In some embodiments, another region of first image 300 and/or another region of a third image may be scanned for a most similar block.

Regions may be selected as candidates for containing a similar block to an individual block of the second image by using any available criteria, such as metadata of the first and the second images. For example, the orientation of the camera when the first and the second images were captured may allow for pinpointing one or more regions within the first image that are most likely to have similar block. In some embodiments, machine learning may be used to learn to select regions that may be similar to a block with a particular position in an image.

Continuing with FIG. 2, to compare two blocks, a difference block is calculated between the chosen individual block of the second image and a chosen individual block within the at least one region of the first image (206). The difference block represents the difference between corresponding matrix values of the two chosen blocks being compared. For example, the difference block may have the numeric values for the difference between DCT coefficients in each color channel. Each color channel may be represented with a matrix of DCT coefficients for the individual block, and the difference may be calculated for each color channel for the difference block by subtracting a matrix of values for the chosen individual block of the second image in the chosen color channel from a matrix of values for the chosen block within the region of the first image in the chosen color channel.

A sum may be calculated for each difference block (208). The sum may be used as a metric for block similarity for the two or more blocks being compared. For example, a matrix of DCT coefficient values for a color channel of an individual block of the second image (B):

$$[ \begin{matrix}2 & 3 & 10 & 5 \\ 5 & 6 & 9 & 4 \\ 3 & 1 & 0 & 2 \\ 4 & 3 & 8 & 7\end{matrix} ]$$

and a matrix of DCT coefficient values for a color channel of an individual block of the first image (A):

$$[ \begin{matrix}3 & 3 & 10 & 6 \\ 6 & 6 & 9 & 4 \\ 8 & 1 & 0 & 2 \\ 4 & 8 & 8 & 6\end{matrix} ]$$

results in a difference matrix of DCT coefficient values (A−B):

$$[ \begin{matrix}1 & 0 & 0 & 1 \\ 1 & 0 & 0 & 0 \\ 5 & 0 & 0 & 0 \\ 0 & 5 & 0 & - 1\end{matrix} ]$$

In the example, an absolute sum of the calculated difference matrix (C=|A−B|) is [2, 1, 5, 6] and/or 14. A sum may be calculated for each color channel (e.g., Y′=15, C_{B}=14, and C_{R}=13). In some embodiments, a total sum approach is used where a total sum of differences between the color channels of the compared blocks (e.g., Y′+C_{B}+C_{R}=42) may be used to determine whether the chosen block of the first image from the region(s) of the first image is the most similar block to the chosen individual block of the second image. For example, if a total sum for the difference block for the chosen individual block of the first image is less than a sum for the difference block of the current most similar block (e.g., Y′+C_{B}+C_{R}=42), then the individual block of the first image associated with the difference block may be tentatively designated the current most similar block to the chosen individual block of the second image.

As detailed in FIG. 5, other approaches may compare each individual color channel for a block, and include the most similar difference matrix for each color channel from any block within the region(s) as the difference representation. For example, color channel Y′ for a given block in the second image may be most similar to a color channel Y′ of a first block of the first image, and color channel C_{B} for the given block may be most similar to a color channel C_{B} of a second block of the first image. Those with skill in the art will recognize when and where different approaches and/or combinations of approaches may be preferred.

In some embodiments, if the sum is below a threshold, then the difference block may be stored for the chosen individual block of the second image. The threshold may initially be set at a maximum sum of differences for a difference block permitted. Alternatively, the threshold may be initialized to the first sum from the comparison between the two blocks, and the threshold may keep getting updated to the sum for the difference block of the current most similar block during the comparison.

In some embodiments, if a sum is below a particular threshold, then the comparison for the chosen individual block may end. For example, to reduce a number of comparisons of individual blocks, a first similar block with a difference block sum that is below a threshold may be used for the difference representation, and the comparison may be performed for the next chosen individual block within the second image (204).

Optionally, a mapping between the difference block and the chosen individual block within the region of the first image may be recorded to enable locating the two blocks during reconstruction of the chosen individual block of the second image. If a total sum approach is used, then there may be one mapping for each block. Alternatively, however, if an approach such as depicted in FIG. 5 is preferred, then a mapping may be provided per color channel for each block such as depicted. The mapping will be described in more detail below with FIG. 3.

A determination may be made as to whether there is a next block within the region of the first image for comparison (210), and if there is a next block, then the comparison may continue with the next block being set as the chosen individual block within the region of the first image (206).

Alternatively, if there are no more blocks within the region of the first image (210), then the difference block from the calculated difference blocks may be provided for inclusion in a difference representation based on the sum (212). The difference block associated with the current most similar block and/or the difference block with smallest sum may be used for the difference representation. The difference block may be used with the chosen individual block within the region of the first image to reconstruct the chosen individual block of the second image.

A determination is made as to whether there is a next individual block of the second image (214). If there is a next block of the second image (214), then the comparing may continue with the next block being set as the chosen individual block of the second image for comparison and the comparing may continue (204).

Alternatively, if there are no more blocks of the second image (214), then the difference representation is compressed for transmission (216). The mapping may be similarly compressed for transmission. The first image is compressed (216) and the information is transmitted (216).

If the images were not found to be similar, then the second image may be compressed for transmission.

FIG. 3 illustrates exemplary blocks from images and a difference representation for batch compression of photos in accordance with some embodiments of the invention. As similar blocks are located between the first image 300 and the second image 314, a mapping between blocks of the difference representation 302 and blocks of the first image 300 may be recorded. For example, block 310 of second image 314 may be most similar to block 304 of region 312 in the first image 300. The resulting difference matrices from the comparison of block 304 and block 310 may form block 306 of the difference representation 302, and block 306 may have a mapping to block 304 recorded such that the block 306 of difference representation 302 and the block 304 of the first image may be used to reconstruct block 310.

In the simplest case, block 310 and 304 may be the first similar blocks identified between the files, and the row and the column for block 304 may serve as the basis or origin for all of the remaining mappings. For example, row 308 and column 316 may be assigned a value of zero, and the mapping for block 304 may be (row, column, image) having values (0, 0, First Image). Continuing with the example, block 324 located next to block 306 of the difference representation may have a mapping (0, 1, First Image) to locate block 326 of the first image 300.

Multiple images may be compared to the second image 314 to find the most similar blocks for comparison. For example, the difference representation 302 may have block 328 that has a mapping (0, 0, Third Image), and the block 328 and block 320 located in accordance with the mapping may be used to reconstruct block 330 of the second image 314. In other embodiments, a particular position of a block may be assigned as an origin. For example, a block located in the lower left corner may serve as a basis or origin for the mapping. Continuing with the example, in such a case, block 304 would have a mapping (2, 0, First Image).

In another embodiment, the mapping may be relative to the positioning of the difference block in the difference representation 302. For example, with a mapping (0, −1, FirstImage), block 324 may be combined with block 304 of first image 300 which is one block to the left of block 326, having a corresponding position with block 324 within first image 300.

As detailed in FIG. 5, different block mappings may be provided for each color channel of a block. For example, with a mapping (0, −1, FirstImage) for color channel Y′ of block 324, color channel Y′ of block 324 may be combined with color channel Y′ block 304 of first image 300 which is one block to the left of block 326, having a corresponding position with block 324 within first image 300 to reconstruct the color channel Y′ of the block for the second image. Whereas, with a mapping (0, 0, First Image) for color channel C_{B} of block 324, color channel C_{B} of block 324 may be combined with color channel C_{B} of block 326 to reconstruct the color channel C_{B} of the block for the second image.

FIG. 4 is a flowchart for batch compression of photos in accordance with some embodiments of the invention. A first image and a second image may be selected (400) as candidates for similarity. Any metadata for the first and the second images and/or techniques may be used to select candidates for similarity. The first and second images may be digital images captured and recorded by a camera 138, and stored at a device, such as client device 102. The first and second images may be compressed using any number of compression algorithms, such as methods implementing JPEG standards.

The first and second images may be uncompressed (402) to allow for comparison of the blocks to determine whether the images are similar. By way of example, the images may be compressed using both a lossy and a lossless compression, and the lossless compression for the first and the second images may be uncompressed. The lossy compression of the images may be used to discard high frequency data from the color channels that the human eye is less sensitive to (e.g., small specks within the image). In other embodiments, lossy compression of the images may not be performed on the first and the second images. The uncompressed images may be divided into blocks allowing for comparison of the individual blocks to determine similarity of the images.

A block of the second uncompressed image may be selected (402). Differences may be calculated between the block of the second uncompressed image and any number of blocks from the uncompressed first image to determine whether the images have similar blocks for each color channel and may be designated as similar for batch compression. In some embodiments, the comparison may be performed between each individual block of the second image and blocks within selected regions of the first image.

At least one region of the first uncompressed image is selected for comparison (406). Each individual block of the second uncompressed image may have particular regions of the first image that are selected for comparison. Regions of the first image may be selected for comparison with an individual block from the second image based any number of criteria and metadata for the images. For example, the regions may be selected based on criteria, including, but not limited to, an initial scan of the first image, success with a particular region and a neighboring block of the second image, metadata from the respective images (e.g. orientation of the camera), and/or any other criteria.

A comparison may be performed between the selected region of the first uncompressed image and the selected block of the second uncompressed image (408). To perform the comparison, differences may be calculated between the block of the second image and each block of the selected region of the first image to locate the most similar block for each color channel within the first image from the selected regions. FIG. 5 provides a detailed description of the comparison. If a similar block for a color channel is found, then the difference for the color channel may be provided to create a difference representation. Optionally, a mapping between the difference used within the difference representation and the block of the first image may be recorded to enable reconstruction of the block from the second image.

If there are more regions selected for comparison with the block of the uncompressed second image (410), then the next region is selected for comparison (406) and the comparison is performed (408) to find the most similar block for each color channel. Although the flowchart describes locating a most similar block for each color channel of blocks of a second image within regions of a first image, those with skill in the art will recognize that regions of any number of images may be scanned for the most similar block.

Alternatively, if there are no more regions selected (410) for comparison and there is a next block of second image (412), then a next block of the second uncompressed image is selected (404). The comparisons for each block of the second uncompressed image may continue to be performed (408) until there are no more blocks of the second uncompressed image for comparison.

Continuing with FIG. 4, if there are no more blocks of second uncompressed image for comparison (412), then a determination is made as to whether the images selected for comparison are similar (414). If there are sufficient number of similar blocks between the second uncompressed image and the first uncompressed image (414), then the first image and the difference representation may be compressed (416).

In some embodiments, a number of similar blocks may need to exceed a limit or a threshold to be designated as similar and warrant transmission of the difference representation and the first image instead of the compressed first and the second images. For example, if there is only one similar block identified between the second image and the selected regions for comparison, then the cost of processing the difference representation to reconstruct the second image may outweigh the benefit of reduced data for transmission.

The compressed first image, the compressed difference representation, and optionally, a compressed mapping may then be transmitted (418). The receiving device may then reconstruct the second image. Those with skill in the art will recognize that the compressed first image and the compressed difference representation do not need to be sent contemporaneously. For example, a first image may be received at a receiving device, and after a period of time, the first image may be modified. Continuing with the example, a difference representation for differences between the first image and the modified image may be transmitted to the receiving device to synchronize and update the first image.

Alternatively, if the first and the second images are not similar (414), then the first and the second images are compressed (420), and the first and the second compressed images are transmitted (424).

FIG. 5 is a flowchart for batch compression of photos in accordance with some embodiments of the invention. FIG. 5 provides further detail on a comparison of a block from a second uncompressed image to each block within a region of the first uncompressed image. A block for the first uncompressed image may be selected from the region of the first uncompressed image (500). A color channel from the block may be selected for comparison (502). For example, each color channel Y′, C_{B}, and C_{R} of the selected block of the first image may be compared to the corresponding color channel of the block from the uncompressed second image.

A difference matrix of DCT coefficients values may be calculated by subtracting a matrix of DCT coefficient values for the color channel of the second uncompressed image from a matrix of DCT coefficient values for the color channel of the block for the first uncompressed image (504). An absolute sum may be calculated for the difference matrix for the color channel (506).

If the sum is below a threshold (508), then the blocks may be recorded as similar for the color channel and the difference matrix and mapping for the block may be stored (510). The threshold may initially be set as a limit for the sum of the differences between the images. For example, the sum of differences may not be above a number (e.g., 100). The threshold may be updated to have the value of the sum for the recently found most similar block for the color channel within the regions selected for comparison. For example, if a threshold is 100 and the recently calculated sum is 8, then the threshold may be assigned a value of 8 for comparison with the next block for the color channel.

The difference matrix may be stored for the current color channel of the current block and provided for creation of the difference representation for the second image if the difference matrix is found to be the most similar for the color channel. Similarly, the mapping may be stored and provided for creation of the mapping for the difference representation if the current block is found to be the most similar for the color channel. The mapping may be recorded as described in detail with FIG. 3.

If there is a next color channel for the block (514), then the next color channel is selected for comparison (502) and the process repeats for comparing the blocks for the next color channel (504). Although an approach is described for processing each color channel of each block before proceeding to the next block, those with skill in the art will recognize that there are various methods for processing each color channel. For example, each block of the second image for a color channel may be processed before proceeding to the next color channel. If there is no next color channel for the block (514), then a determination is made as to whether there is a next block of the first uncompressed image (518).

Alternatively, if the sum is not below a threshold (508), then the block is recorded as not similar (512) for the color channel. When the block is recorded as not similar for the color channel (512), a determination is made as to whether there is another block of first compressed image for comparison (514). If there is a next color channel (514), then a next color channel is selected for comparison (502).

Continuing with FIG. 5, if there is a next block of first uncompressed image for comparison (518), then the process continues with comparison of the next block (500). Alternatively, if there are no more blocks of the first uncompressed image for comparison (518), then a determination is made as to whether the selected regions had a similar block (520). If the selected regions had a similar block, then the stored difference matrices for each color channel are provided for creation of the difference representation (524) and the comparison ends. For example, the difference matrices for each color channel provided for the difference representation may be from one or more blocks. Continuing with the example, a Y′ and C_{R} difference matrix from one block of the first image may be used and a C_{B} difference matrix of another block of the first image may be used. In this example, a mapping may be provided for each difference matrix for a color channel within the difference representation. Optionally, a mapping may be provided for the similar block from the first uncompressed image for each color channel. Alternatively, if there are no similar blocks (520), then the comparison ends.

FIG. 6 is a flowchart for batch compression of photos in accordance with some embodiments of the invention. A mapping, a compressed first image, and a compressed difference may be received to reconstruct a second image (600). The first image and the difference representation may be uncompressed (602). Optionally, the mapping may be compressed and may be uncompressed to perform the reconstruction of the second image.

Each block of the difference representation may be selected from the difference representation (604). A mapping may be retrieved for the selected block of the difference representation (606). The block of the second image may be reconstructed using the mapping (608). FIG. 7 provides a detailed description of the reconstruction of a block of the second image (608). If there is a next block (610), then the process continues for reconstructing the next block (606). Alternatively, if there are no more blocks to reconstruct (610), then the second image reconstructed with the provided reconstructed blocks is compressed (612).

FIG. 7 is a flowchart for batch compression of photos in accordance with some embodiments of the invention. A color channel is selected for the block from the difference representation (700). A block is located from the first image for the color channel using the mapping (702). For example, the mapping may provide (−1, 0, First Image) to locate a block in the first image, and as shown in FIG. 3, by way of example, block 326 may be located in at (−1, 0) with the mapping.

The located block from the first image may be added to the block from the difference representation for the color channel to reconstruct values for the color channel of the block for the second image (704).

For example, a matrix of DCT coefficient values for the block of the second image (B=A+B Δ) may be reconstructed:

$$[ \begin{matrix}2 & 3 & 10 & 5 \\ 5 & 6 & 9 & 4 \\ 3 & 1 & 0 & 2 \\ 4 & 3 & 8 & 7\end{matrix} ]$$

when a matrix of DCT coefficient values for a block of the first image (A):

$$[ \begin{matrix}3 & 3 & 10 & 6 \\ 6 & 6 & 9 & 4 \\ 8 & 1 & 0 & 2 \\ 4 & 8 & 8 & 6\end{matrix} ]$$

is added to a difference matrix of DCT coefficient values (B Δ):

$$[ \begin{matrix}1 & 0 & 0 & 1 \\ 1 & 0 & 0 & 0 \\ 5 & 0 & 0 & 0 \\ 0 & 5 & 0 & - 1\end{matrix} ]$$

After the color channel for the block of the second image has been reconstructed (704), a determination is made as to whether the values of a block may need to be reconstructed for a next color channel (706). If there is a next color channel of values to reconstruct for the block (706), then the process continues with the next color channel (700). If there are no more values to restore for the block (706), then the reconstructed block is provided for the reconstructed second image (708).

FIG. 8A and FIG. 8B illustrate exemplary similarity candidates for batch compression in accordance with some embodiments of the invention. FIG. 8C illustrates an exemplary difference representation in accordance with some embodiments of the invention. First image 800 and second image 802 are candidates for similarity and batch compression. The difference representation 804 is created as a result of the comparison of the first 800 and second images 802, and the difference representation 804 may be transmitted with first image 800 and/or to a device that has a copy of first image 800 to enable reconstruction of the second image 802.

Any suitable programming language can be used to implement the routines of particular embodiments including C, C++, Java, JavaScript, Python, Ruby, CoffeeScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time

Particular embodiments may be implemented in a computer-readable storage device or non-transitory computer readable medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described collections and methods for presenting collections thereof, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

What is claimed is:

1. A method of batch compression of photos, the method comprising:
selecting first and second images, each image comprising a plurality of individual blocks and each individual block is defined by at least one matrix whose values are indicative of pixel data within the individual block;
for each individual block of the second image:
comparing a chosen individual block of the second image to each individual block within at least one region of the first image, by:
calculating a difference block between the chosen block of the second image and a chosen block within the at least one region of the first image, the difference block comprising a difference between corresponding matrix values of the two blocks being compared; and
calculating a sum for the calculated difference block as a similarity metric for the two blocks being compared;
providing a similar difference block from the calculated difference blocks for inclusion in a difference representation based on the corresponding sum, the similar difference block operable with the chosen block within the at least one region of the first image to reconstruct the chosen individual block of the second image;
compressing the difference representation and the first image, wherein the difference representation is operable with the first image to reconstruct the second image; and
transmitting the compressed information.

2. The method of claim 1, wherein the at least one matrix of values comprise discrete cosine transform coefficients.

3. The method of claim 1, wherein the at least one matrix of values comprises one of pixel values and results of operations with pixel values.

4. The method of claim 1, wherein the comparing further comprises:
calculating the difference for each color channel by subtracting a matrix of values for a chosen color channel of the chosen block of the second image from a matrix of values for the chosen color channel of the chosen block within the at least one region of the first image; and
calculating the sum for the calculated difference block, the sum comprising a result of addition of a sum for each calculated difference.

5. The method of claim 1, wherein the method further comprises:
determining whether the difference block is a similar block based on the sum, wherein the determining comprises:
upon a determination that the sum for the difference block is below the threshold, providing the difference block for creation of the difference representation; and
upon a determination that the sum is not below the threshold, performing at least one of assigning a next block of the second image as the chosen block for the comparison and designating the images as not similar.

6. The method of claim 1, wherein the selected first and second images are compressed images using a lossy compression algorithm and a lossless compression algorithm, the method further comprising:
uncompressing the selected first and the second images using the lossless compression algorithm.

7. The method of claim 1, the method comprising:
uploading a mapping for the at least one difference block from the difference representation, wherein the mapping indicates a location within the first image for the at least one block to combine with the at least one difference block to reconstruct the individual block for the second image.

8. The method of claim 1, wherein the first and second images are selected for comparison based on a proximity of creation time for the first and the second images.

9. The method of claim 1, the method further comprising:
detecting modifications to the first and the second images; and
transmitting the compressed information to a client device to synchronize the first and the second image files stored on the client device.

10. The method of claim 1, the method further comprising:
receiving a request at a content management system to share the first and the second images; and
transmitting the compressed information to the content management system.

11. A method of batch compression of photos, the method comprising:
receiving a mapping, a first image, and a compressed difference representation to reconstruct individual blocks of a second image;
uncompressing the first image and the difference representation;
reconstructing each individual block of the second image provided with the difference representation, the reconstructing comprises:
retrieving a block mapping for an individual block of the difference representation from the mapping;
locating an individual block of the first image using the block mapping;
creating a reconstructed block by adding the individual block of the difference representation to the individual block of the first image; and
providing the reconstructed block for reconstruction of the second image.

12. A non-transitory computer readable medium containing instructions that, when executed by at least one processor of a computing device, cause the computing device to:
select first and second images, each image comprising a plurality of individual blocks and each individual block is defined by at least one matrix whose values are indicative of pixel data within the individual block;
for each individual block of the second image:
comparing a chosen individual block of the second image to each individual block within at least one region of the first image, by:
calculating a difference block between the chosen block of the second image and a chosen block within the at least one region of the first image, the difference block comprising a difference between corresponding matrix values of the two blocks being compared; and
calculating a sum for the calculated difference block as a similarity metric for the two blocks being compared;
providing a similar difference block from the calculated difference blocks for inclusion in a difference representation based on the corresponding sum, the similar difference block operable with the chosen block within the at least one region of the first image to reconstruct the chosen individual block of the second image;
compress the difference representation and the first image, wherein the difference representation is operable with the first image to reconstruct the second image; and
transmit the compressed information.

13. The non-transitory computer readable medium of claim 12, wherein the at least one matrix of values comprise discrete cosine transform coefficients.

14. The non-transitory computer readable medium of claim 12, wherein the at least one matrix of values comprises one of pixel values and results of operations with pixel values.

15. The non-transitory computer readable medium of claim 12, containing instructions that, when executed, further cause the computing device to:
calculate the difference for each color channel by subtracting a matrix of values for a chosen color channel of the chosen block of the second image from a matrix of values for the chosen color channel of the chosen block within the at least one region of the first image; and
calculate the sum for the calculated difference block, the sum comprising a result of addition of a sum for each calculated difference.

16. The non-transitory computer readable medium of claim 12, containing instructions that, when executed, further cause the computing device to:
determine whether the difference block is a similar block based on the sum, wherein the determining comprises:
upon a determination that the sum for the difference block is below the threshold, providing the difference block for creation of the difference representation; and
upon a determination that the sum is not below the threshold, performing at least one of assigning a next block of the second image as the chosen block for the comparison and designating the images as not similar.

17. The non-transitory computer readable medium of claim 12, wherein the selected first and second images are compressed images using a lossy compression algorithm and a lossless compression algorithm, the non-transitory computer readable medium containing instructions that, when executed, further cause the computing device to:
uncompress the selected first and the second images using the lossless compression algorithm.

18. The non-transitory computer readable medium of claim 12, containing instructions that, when executed, further cause the computing device to:
upload a mapping for the at least one difference block from the difference representation, wherein the mapping indicates a location within the first image for the at least one block to combine with the at least one difference block to reconstruct the individual block for the second image.

19. The non-transitory computer readable medium of claim 12, wherein the first and second images are selected for comparison based on a proximity of creation time for the first and the second images.

20. The non-transitory computer readable medium of claim 12, containing instructions that, when executed, further cause the computing device to compare the block of the second image by:
detect modifications to the first and the second images; and
transmit the compressed information to a client device to synchronize the first and the second image files stored on the client device.

21. The non-transitory computer readable medium of claim 12, containing instructions that, when executed, further cause the computing device to:
receive a request at a content management system to share the first and the second images; and
transmit the compressed information to the content management system.

22. A non-transitory computer readable medium containing instructions that, when executed by at least one processor of a computing device, cause the computing device to:
receive a mapping, a first image, and a compressed difference representation to reconstruct individual blocks of a second image;
uncompress the first image and the difference representation;
reconstruct each individual block of the second image provided with the difference representation, the reconstructing comprises:
retrieve a block mapping for an individual block of the difference representation from the mapping;
locate an individual block of the first image using the block mapping;
create a reconstructed block by adding the individual block of the difference representation to the individual block of the first image; and
provide the reconstructed block for reconstruction of the second image.

23. A system for batch compression of photos, the system comprising:
one or more processors; and
memory containing instructions that, when executed, cause one or more processors to:
select first and second images, each image comprising a plurality of individual blocks and each individual block is defined by at least one matrix whose values are indicative of pixel data within the individual block;
for each individual block of the second image:
comparing a chosen individual block of the second image to each individual block within at least one region of the first image, by:
calculating a difference block between the chosen block of the second image and a chosen block within the at least one region of the first image, the difference block comprising a difference between corresponding matrix values of the two blocks being compared; and
calculating a sum for the calculated difference block as a similarity metric for the two blocks being compared;
providing a similar difference block from the calculated difference blocks for inclusion in a difference representation based on the corresponding sum, the similar difference block operable with the chosen block within the at least one region of the first image to reconstruct the chosen individual block of the second image;
compress the difference representation and the first image, wherein the difference representation is operable with the first image to reconstruct the second image; and
transmit the compressed information.

24. A system for presenting content items using a collections view, the system comprising:
one or more processors; and
memory containing instructions that, when executed, cause one or more processors to:
receive a mapping, a first image, and a compressed difference representation to reconstruct individual blocks of a second image;
uncompress the first image and the difference representation;
reconstruct each individual block of the second image provided with the difference representation, the reconstructing comprises:
retrieving a block mapping for an individual block of the difference representation from the mapping;
locating an individual block of the first image using the block mapping;
creating a reconstructed block by adding the individual block of the difference representation to the individual block of the first image; and
providing the reconstructed block for reconstruction of the second image.
